(19) United States
(12) Patent Application Publication
(10) Pub. No.: US 2013/0073582 A1
(43) Pub. Date: Mar. 21, 2013

(54) WEB SEARCH RESULTS WITH LIVE DATA

(71) Applicant: Prabhakaran Krishnamoorthy, Bangalore (IN)

(72) Inventor: Prabhakaran Krishnamoorthy, Bangalore (IN)

(73) Assignee: Yahoo! Inc., Sunnyvale, CA (US)

(21) Appl. No.: 13/234,333

(22) Filed: Sep. 16, 2011

(51) Int. Cl. G06F 17/30

(52) U.S. Cl. 707/769; 707/E17.014

(57) ABSTRACT

A system and method for receiving a search request comprising one or more key words; providing a plurality of web links associated with search results generated responsive to the search request; providing a portion of dynamic information associated with the search results; and rendering a search results page to include the portion of the dynamic information along with the search results.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of search and more particularly relates to the field of customizing search results.

### BACKGROUND OF THE INVENTION

Relevance in search results is an important issue which many search engines attempt to address. Currently, search results are listed on a search results page with a few lines of text that provide information about the web site hosting the uniform resource locator (URL) pointed to by the search result. Although this information can be useful, it lacks any dynamic information that would improve the search experience and provide more relevance to the user.

There is a need for a system and method to address this shortcoming in the known art.

### SUMMARY OF THE INVENTION

Briefly, according to an embodiment of the invention, a computer-implemented method includes steps or acts of: receiving a search request comprising one or more key words; providing a plurality of web addresses associated with search results generated responsive to the search request; providing a dynamic message associated with the search results; and rendering a search results page to include the dynamic message along with the search results.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a flowchart of a method for rendering live information, according to an embodiment of the invention;

FIG. 2 shows an exemplary screenshot of a search results page showing live information, according to an embodiment of the present invention;

FIG. 3 shows an exemplary screenshot of a search results page showing live information, according to an embodiment of the present invention;

FIG. 4 shows an exemplary screenshot of a search results page showing live information, according to an embodiment of the present invention;

FIG. 5 is a simplified block diagram of a system for rendering live information on a search results page;

FIG. 6 is a high level block diagram showing an information processing system according to another embodiment of the invention;

FIG. 7 is flowchart of a method for rendering live information according to another embodiment of the present invention;

FIG. 8A shows a pricing icon according to an embodiment of the present invention; and

FIG. 8B shows an information icon according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe how to implement search results with live data that is more meaningful to a search user. Currently, a search results page (SRP) will allocate approximately three or four rows of text to describe each displayed link of a search. For sponsored search, advertisements are displayed to the right of the displayed results. We use this allocated space to customize the search result listing by aggregating a display of meta information or a page or page segment of a displayed page. In this space we provide dynamic information that is related to the user's search query and can be personalized to the user's geographical information, and/or personal information. The dynamic information can be provided in the description area, or close to the displayed link, on the right or left side of the displayed search result. With the aggregation of this dynamic information, the user receives more useful and up-to-date information. The ability to generate revenue for both the website and the search provider is also improved by providing a user with more relevant and customized search results.

The dynamic information can include marketing information, live deals (such as current sale offerings, special promotions, discounts, and so forth), profiled content (based on sex, age, location, time, etc.) and customized content based on the search keywords, thus producing customized result displays. This also addresses the problem of page crawling delays because, as part of the request to the web site (or the web site's proxy), the description of the web link, provided by the search engine, is also passed to the web site. From this description it is possible to discern the version of the document crawled by the web site. Also, by verifying the cached copies' signature, it is possible to confirm the crawled copies' version.

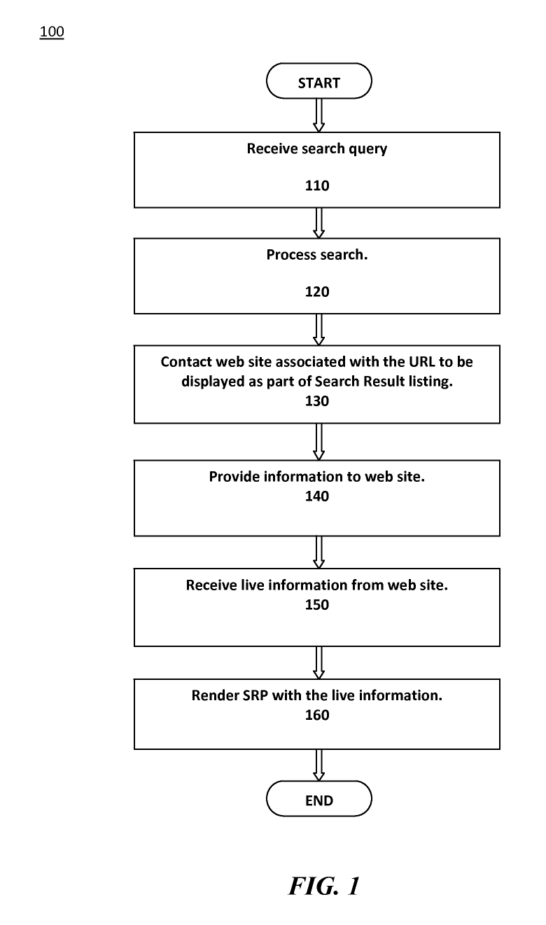

Referring now to the drawings and to FIG. 1 in particular, we show a flowchart 100 of one method for displaying live information on a search results page (SRP). In step 110 the search engine receives a search query. Next, in step 120 the search query is processed as usual to generate a SRP with relevant search results. As part of rendering the search results some portion of the allocated lines is left empty. It is possible, however, to use any space that is available to the right of the link. Also it may be possible to use the space available below the link. Depending on the requirement, the right implementation may be selected.

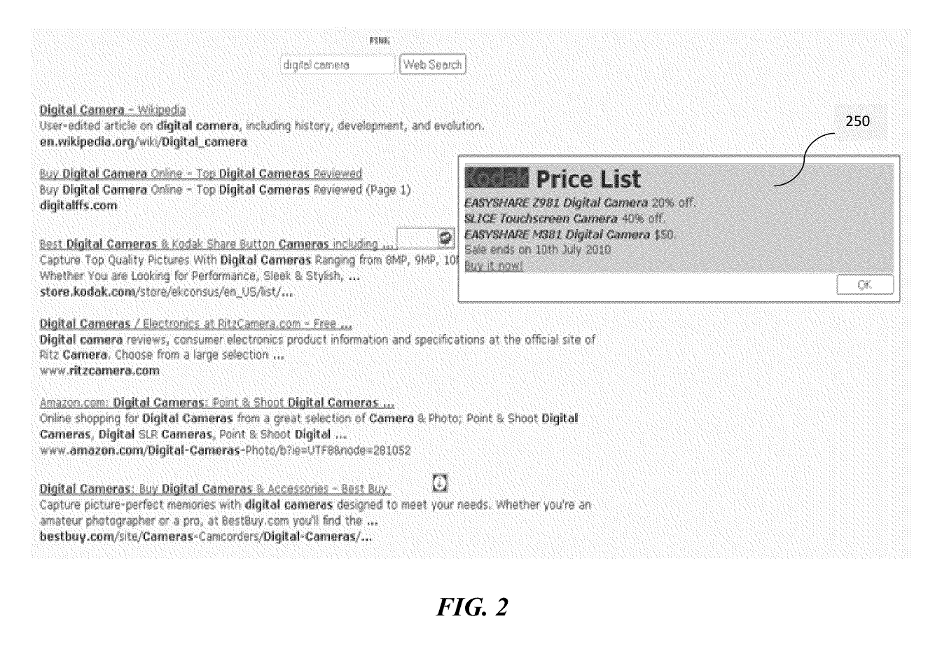

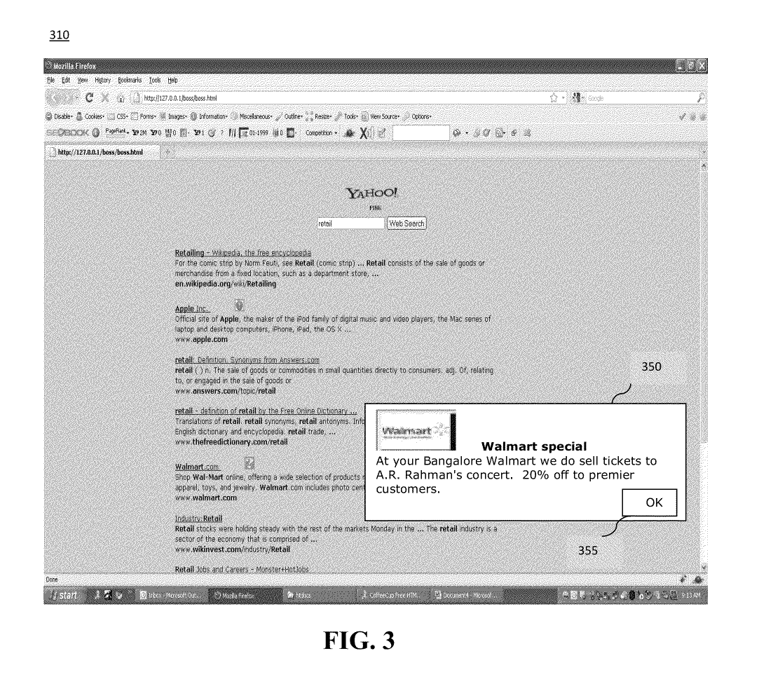

Next in step 130 we contact the web sites associated with the links to be displayed in order to receive relevant information to use in a dynamic message to be rendered as part of the search results. It is possible to provide “dynamic message” for more than one link. In the displayed search results as shown in FIGS. 2 and 3, a special icon is displayed next to two of the links. The icon indicates what type of dynamic message is available. If user clicks on or hovers over the icon the special message will be displayed. Additionally, in another embodiment the space below the web link (one or two lines) could be used to display the special dynamic message.

As part of contacting the web site, we are able to provide a timeframe in which to receive the information. If the web site doesn't return results within the stipulated time no dynamic message will be displayed. Using AJAX (Asynchronous JavaScript and XML) or other technology, the appropriate website is contacted to obtain live information from the website and display it. AJAX is a group of interrelated web development methods used on the client-side to create interactive web applications. With AJAX, web applications can retrieve data from a server asynchronously in the background without interfering with the display and behavior of the existing page. Despite the name, the use of XML is not needed, and the requests need not be asynchronous.

In contacting the web site, we can provide the web site with information that will help generate live information that is customized to the user and/or the user's request. For example, we can provide some or all of the following information: a) site to be rendered; b) the search key words; c) information about the person searching; and d) the location, time, and so on of the person searching.

In step 140 we receive the live information provided by the web site and prepare it for rendering as a dynamic message. This dynamic message can be a catch phrase, marketing information, product information (live deals), profiled content, customized content, and so on. It can be presented as text, image, special text, sub URL, audio, video, and so forth. The special message can be displayed with different font color, highlighting, blinking, and so forth depending on various criteria like user age, sex, location, etc.

In step 160 we render the SRP with a window containing this special message, along with an icon indicating the type of message. Alternatively, the icon is displayed without the message. In this case, the message can be presented to the user when the user clicks on the icon or hovers over the icon. In another embodiment, just the message is displayed along with the search results. In this manner, the displayed search results will include both useful information from the search engine and live updates from the displayed website. Even though the SRP has been rendered (+URL) depending on feedback from the web site, local page redirection could be performed. So that when the user clicks on the link it could be redirected to a more relevant page. When clicked on the link, the page might be redirected to a link provided by the search engine. Based on the feedback from the web site the client site scripts could replace the URL provided by the search engine, to be redirected on click, by the URL provided by the Web site or its proxy. Depending on the information provided by the search engine components (like search term, sex, time), the user location, and browser cookie information, the web site could select the appropriate message for the user. From the browser cookie, the web site is able to discern whether the customer is an existing/registered customer or a new customer.

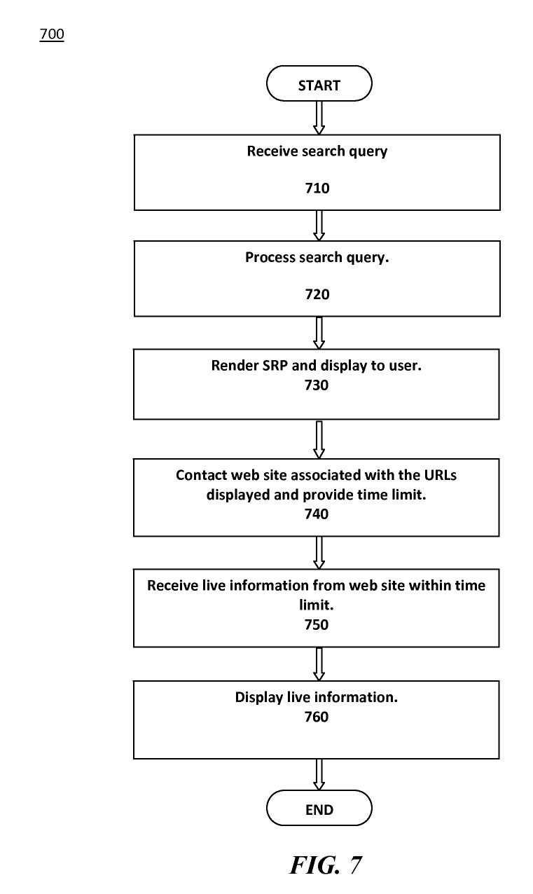

Referring now to FIG. 7 we show a flowchart 700 of another method for displaying live information on a search results page (SRP). This method begins in the same manner as described in the flowchart of FIG. 1. In step 710 the search engine receives a search query. Next, in step 720 the search query is processed as usual to generate a SRP with relevant search results. The method deviates here at step 730 where we first render and display the search results to the user (without the live information). Then, in step 740, we contact the web sites associated with the URLs on the SRP in order to receive relevant information to use in a dynamic message to be rendered. At the time that we contact the web sites, we provide a time limit for a response. If the web sites respond with the information within the stated time frame in step 750, then in step 760 we display the live information on the displayed SRP.

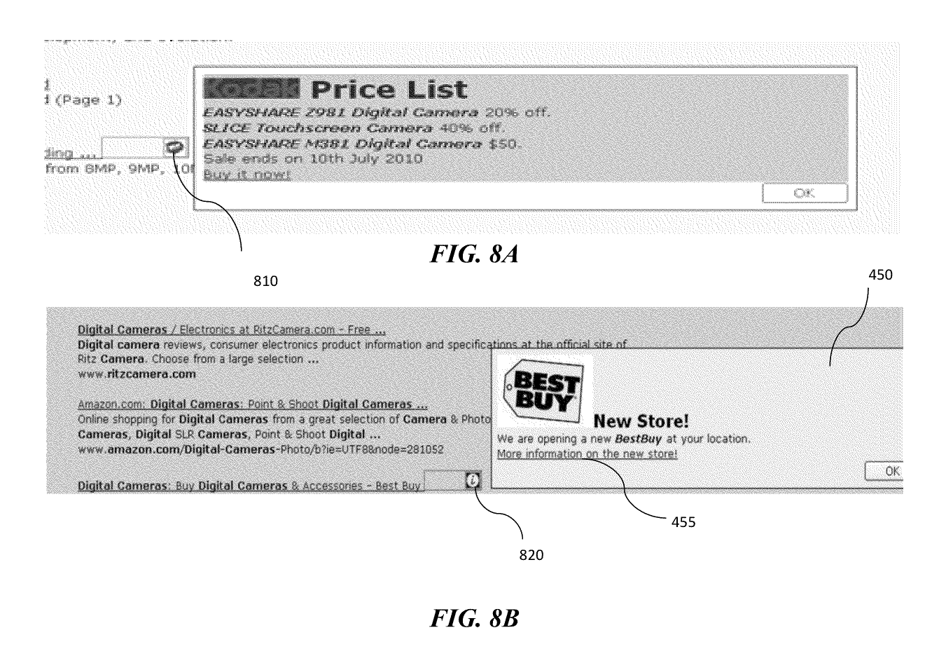

FIG. 2 is an exemplary screenshot of a SRP 210 with a window 250 displaying the special message. In the example of FIG. 2, the SRP 210 is displayed for a search on “digital camera.” For the Kodak search result listing, the host site for the URL provided was contacted to produce the useful information displayed in the window 250. Window 250 displays useful, live information such as the current sale markdown on digital cameras. Referring to FIG. 8A, there is shown the special message which in this case shows a price list for Kodak cameras. The small icon 810 next to the link indicates the type of special message that is displayed. In this example, icon 810 indicates that the special message is related to pricing information. The user can roll-over or hover over the icon 810 to display the type of message. Clicking directly on the icon 810 will provide a detailed description. FIG. 8B shows an informational message icon 820.

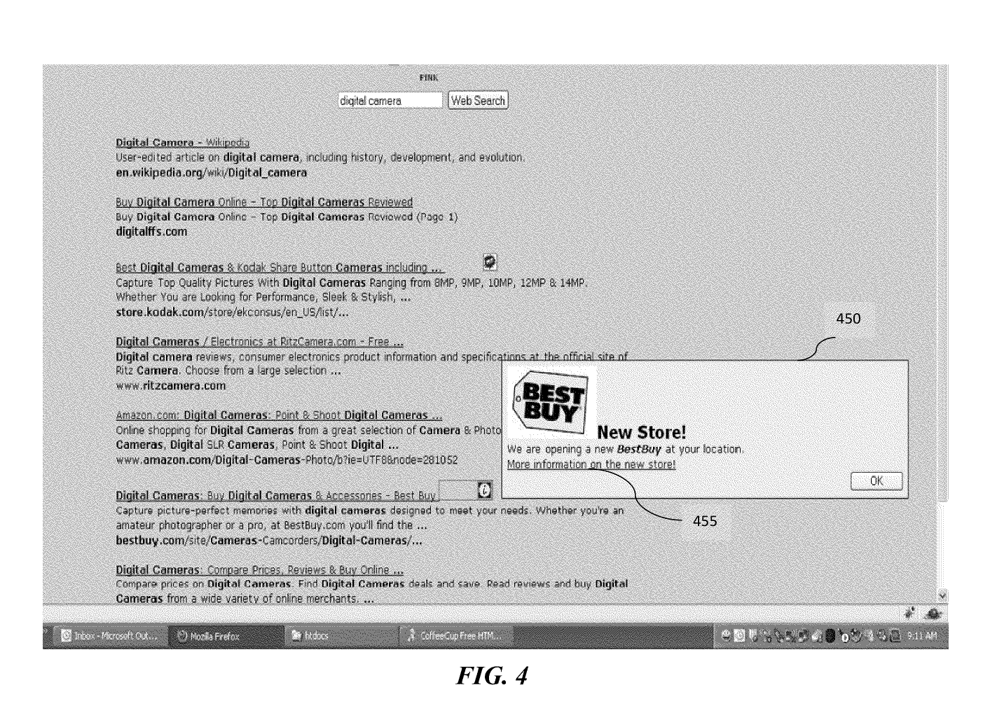

In the embodiment where the icon is displayed alongside the search result, the message can be viewed by hovering over or clicking on the icon. When the user clicks the icon then a message similar to the one shown as message 350 in FIG. 3 or 450 in FIG. 4 will be displayed. Different icons can represent different types of messages. For example, a sale icon indicates sale related information; an informational icon indicates more useful information related to what the user is looking for; an alert icon indicates a new product or similar product related alert. Other contemplated icons are: a warning icon, surprise icon, and others. It should be understood that any number of icon designs are contemplated within the spirit and scope of the invention.

FIG. 3 shows another exemplary screenshot of a SRP 310 displaying a dynamic message 350. The window 350 displays live information that is personalized to the user's location and preferences. The window 350 alerts the user that his/her local Walmart sells tickets to a concert that is likely to appeal to the user based on his/her preferences and previous inquiries. FIG. 4 shows another exemplary screenshot of a SRP 410 displaying a dynamic message 450. In this example, the user's location has been used to generate a special message about a store opening near the user's location. The user can be redirected to the new store website by clicking on the redirect message 455.

An obsolete page due to stale search engine data could be addressed this way. As part of the information provided to the web site, the landing page URL is also provided to the web site. The web site can determine if the provided landing page URL is a non-existing URL or valid one. The web site can then send back the appropriate URL/description as part of the message. The message type may be “broken URL” and the actual message could contain the valid URL. In another embodiment, the landing page URL could be replaced by the new URL.

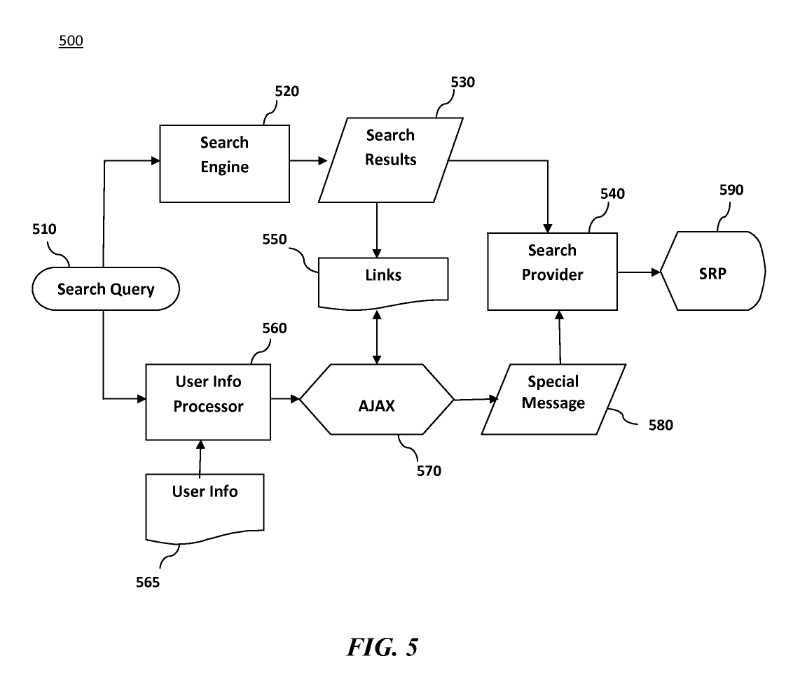

With reference now to FIG. 5, a pictorial representation of an information processing system 500 in which the present invention may be implemented is depicted in accordance with certain presently preferred embodiments of the invention. In general, the routines which are executed when implementing these embodiments, whether implemented as part of an operating system or a specific application, component, program, object, module or sequence of instructions, will be referred to herein as computer programs, or simply programs. The computer programs typically include one or more instructions that are resident at various times in various memory and storage devices in an information processing or handling system such as a computer, and that, when read and executed by one or more processors, cause that system to perform the steps necessary to execute steps or elements embodying the various aspects of the invention.

As shown in FIG. 5, the Search Engine 520 receives the Search Query 510 and generates Search Results 530. Before rendering the Search Results 530 on the SRP 590, an asynchronous operation 570 is performed, communicating with the web sites associated with the Links 550 included in the Search Results 530. This asynchronous operation 570 may be performed using AJAX as discussed previously. The asynchronous operation 570 receives input generated by the User Info Processor 560.

The User Info Processor 560 provides personalized user information to the asynchronous operation 570. The Processor 560 receives as input the User Info 565 (such as location, age, sex, preferences, etc.) from a user profile and also the Search Query 510. Using the search terms from the Search Query 510 and User Info 565, the User Info Processor 560 triggers the asynchronous operation 570. The asynchronous operation 570 contacts the web site hosts hosting the Links 550, providing the personalized information. The web site hosts in turn provide live data (such as a catch phrase, product information, local information, etc.) that is used to generate a special message 580. The Search Provider 540 combines the Special Message 580 with the Search Results 530 to generate the SRP 590. For sponsored tags, as in sponsored search, the Search Provider 540 could add static text (based on a request by the website host) as part of the SRP 590, thus providing more opportunities to generate revenue. The request to the web site for live information could be initiated from the browser also. Search engine inserts certain script to contact the web sites/proxy to get the dynamic information and display to the user. To avail the dynamic message feature the web sites might require to signup with the search engine or it might contact a standard URL (such as www.walmart.com/dynamicinformation). The search engine could charge these web sites a fee. The fee could be pay per click, monthly, annually, etc.

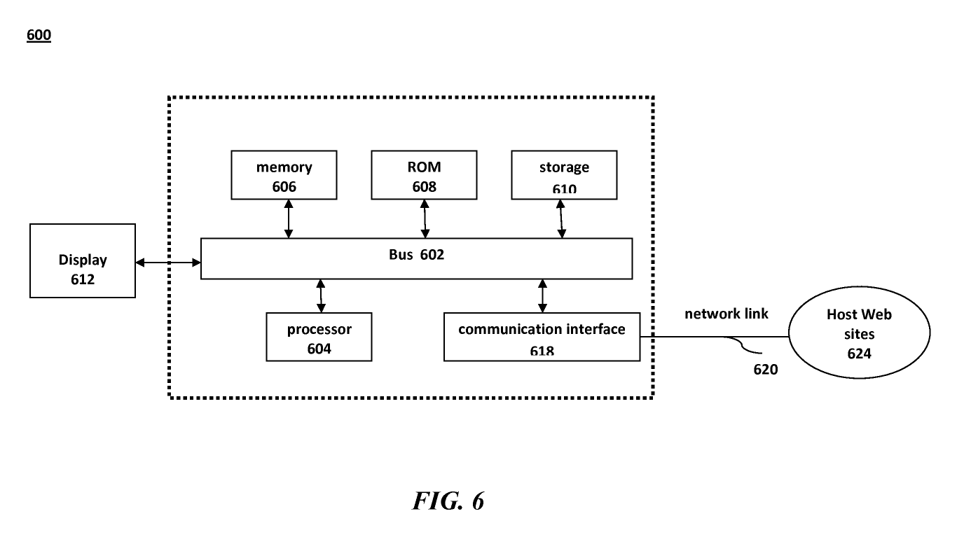

Referring now to FIG. 6 there is shown a high-level block diagram illustrating an information processing system 600 upon which an embodiment of the present invention may be implemented. System 600 includes a bus 602 or other communication mechanism for communicating information, and one or more processors, such as processor device 604 coupled with bus 602 for processing information. System 600 also includes a main memory 606, such as a random access memory (RAM) or other dynamic storage device, coupled with bus 602 for storing information and instructions to be executed by processor device 604 for carrying out the steps in the flow chart of FIG. 1.

Main memory 606 also may be used for storing temporary variables or other intermediate information during execution of instructions to be executed by processor device 604. System 600 further includes, inter alia, a read only (ROM) memory 608 or other static storage device, coupled with bus 602 for storing static information and instructions for processor device 604. A storage device 610, such as a magnetic disk or optical disk, is provided and coupled with bus 602 for storing information and instructions. The storage 610 stores the search keywords and/or user information.

In an embodiment of the present invention, computer system 600 is used for implementing a search engine (or search engines) to produce optimized search results using live data. According to one embodiment of the invention, the live information is provided by system 600 in response to processor device 604 executing one or more sequences of one or more instructions contained in memory 606.

System 600 also includes a communication interface 618 providing a two-way communication coupling with a network link 620. Examples of a communications interface 618 may include a modem, a network interface (such as an Ethernet card), a communications port, a PCMCIA slot and card, etc. Software and data transferred via communications interface 618 are in the form of signals which may be, for example, electronic, electromagnetic, optical, or other signals capable of being received by communications interface 618. These signals are provided to communications interface 618 via a communications path (i.e., channel). The communications interface 618 further is enabled to receive input 640 from the computer user.

Network link 620 typically provides data communication through one or more networks to other devices. Network link 620 may provide a connection through local network 622 to a host computer 624 or to a web browser providing access, through the Internet to a Search Engine.

As will be appreciated by one skilled in the art, the present invention may be embodied as a system, method or computer program product. Accordingly, the present invention may take the form of an entirely hardware embodiment or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

What has been shown and discussed is a highly-simplified depiction of a programmable computer apparatus. Those will knowledge in the art will appreciate that other low-level components and connections are required in any practical application of a computer apparatus capable of performing the described invention.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for displaying web search results with live data, said method comprising:
using a processor device configured to perform:
receiving a search request comprising one or more key words;
providing a plurality of web links associated with search results generated responsive to the search request;
providing a portion of dynamic information associated with the search results; and
rendering a search results page to include the dynamic information along with the search results.

2. The method of claim 1 wherein rendering the search results page comprises making a portion of the search results page available for the portion of the dynamic information.

3. The method of claim 2 wherein making the portion of the search results page visibly available comprises leaving at least one row of text empty.

4. The method of claim 2, further comprising providing a graphical element in close proximity to at least one of the web links to indicate that the dynamic information is available for said at least one of the web links.

5. The method of claim 4, wherein hovering over the graphical element causes a display of the dynamic information.

6. The method of claim 1, wherein the dynamic information comprises marketing information.

7. The method of claim 1, wherein the dynamic information comprises a link to redirect a user to a web page providing more relevant information

8. The method of claim 1 further comprising a step of accessing a website host associated with one of the plurality of web addresses in order to retrieve the dynamic information relevant to the search query.

9. The method of claim 8 further comprising providing user information to the website host.

10. The method of claim 8 further comprising adding static text to the dynamic information when requested by the website host.

11. A computer program product for displaying web search results with live data, the computer program product comprising:
a non-transitory computer readable storage medium having computer readable program code embodied therewith, the computer readable program code causing a processor device to perform a method comprising:
receiving a search request comprising one or more key words;
providing a plurality of web links associated with search results generated responsive to the search request;
providing a portion of dynamic information associated with the search results; and
rendering a search results page to include the portion of the dynamic information along with the search results.

12. The computer program product of claim 11 wherein rendering the search results page comprises making a portion of the search results page available for the dynamic information.

13. The computer program product of claim 12 further comprising providing a graphical element in close proximity to at least one of the web links to indicate that the dynamic information is available for said at least one of the web links.

14. The computer program product of claim 13 wherein hovering over the graphical element causes a display of the dynamic information.

15. The computer program product of claim 11, wherein the dynamic information comprises marketing information.

16. The computer program product of claim 11, wherein the dynamic information comprises a link that redirects a user to web page providing more relevant information.

17. The computer program product of claim 11 further comprising a step of accessing a website host associated with one of the plurality of web addresses in order to retrieve the dynamic information relevant to the search query.

18. The computer program product of claim 17 further comprising providing user information to the website host.

19. The computer program product of claim 17 further comprising adding static text to the dynamic information when requested by the website host.

20. A computer system apparatus comprising:
a processor device; and
an information storage device storing data and instructions causing the processor device to perform a method comprising:
receiving a search request comprising one or more key words;
providing a plurality of web links associated with search results generated responsive to the search request;
providing a portion of dynamic information associated with the search results; and
rendering a search results page to include the portion of the dynamic information along with the search results.
